(19) United States
(12) Patent Application Publication
(10) Pub. No.: US 2023/0121458 A1
(43) Pub. Date: Apr. 20, 2023

(54) PILOT OXYGEN MASK INTEGRATED WITH BONE CONDUCTION SYSTEM

(71) Applicant: B/E AEROSPACE SYSTEMS GMBH, Lübeck (DE)

(72) Inventors: Bhavik Mugeraya, Bangalore (IN); Venkatesh Balakrishnan, Bangalore (IN); Detlev Degenhardt, Stockelsdorf (DE); Pavel Bonev, Lübeck (DE)

(73) Assignee: B/E AEROSPACE SYSTEMS GMBH, Lübeck (DE)

(21) Appl. No.: 17/841,540

(22) Filed: Jun. 15, 2022

(30) Foreign Application Priority Data
Oct. 18, 2021 (IN) 202141047244

(51) Int. Cl. A62B 18/08; A62B 18/02; A62B 7/14; H04R 1/10; G10K 11/178

(52) U.S. Cl. CPC A62B 18/084; A62B 18/02; A62B 7/14; H04R 1/10; G10K 11/17823; H04R 2460/13

(57) ABSTRACT

A respiratory mask system is presented. This respiratory mask system includes an inflatable harness and a bone conduction device to provide audio to a user while wearing the respiratory mask system. The bone conduction device is installed on or interconnected with a portion of the inflatable harness, such as a tube of the inflatable harness that is positioned at least somewhat in proximate to a user's ear. Inflation of the inflatable harness may press the bone conduction device against the user to enhance the delivery of audio to the user.

### CROSS-REFERENCE TO RELATED APPLICATIONS

This application claims priority to, and the benefit of, India Patent Application No. 202141047244 (DAS Code 1CA9) filed Oct. 18, 2021 and titled “PILOT OXYGEN MASK INTEGRATED WITH BONE CONDUCTION SYSTEM,” which is incorporated by reference herein in its entirety for all purposes.

### FIELD

The present disclosure generally relates to the field of respiratory mask systems and, more particularly, to audio for such respiratory mask systems.

### BACKGROUND

Pilots of aircraft may be required to don an emergency oxygen mask. In such a case, a pilot may have to wear a separate headset to continue to hear the audio. Donning both an oxygen mask and a headset may take time that could be allocated to one or other activities in such a situation, which may be during the occurrence of a stressful/emergency event. Wearing a headset in combination with an oxygen mask also can be uncomfortable for the pilot.

In an emergency condition, a pilot may first remove his/her headphones and then remove the oxygen mask from a stowage container. Pilots oftentimes use both hands to position the headphones back on their head, leading to removing their hand away from the control stick of the aircraft for a few seconds. As such, using a separate oxygen mask and audio headset may present one or more issues to pilots.

### SUMMARY

A respiratory mask system is presented herein. The configuration of such a respiratory mask system, the operation of such a respiratory mask system, and the use of such a respiratory mask system are all within the scope of this Summary.

A respiratory mask system includes a mask and an inflatable harness. A bone conduction device is interconnected with a portion of the inflatable harness, and is operable to provide audio to a user that is wearing the respiratory mask system. An oxygen supply tube, line, or conduit is fluidly connectable with the mask.

The respiratory mask system may be characterized as reusable, may be used for any appropriate application and including without limitation for use within an aircraft and including by a pilot or other aircraft crewmember, or both. The mask may be of any appropriate configuration, such as what may be characterized as a full-face configuration (e.g., where the mask includes a lens; where an enclosed space provided by the mask includes the user's mouth, nose, and eyes) or otherwise (e.g., where an enclosed space provided by the mask includes the user's mouth and nose, but excludes the user's eyes).

In addition to the noted bone conduction transducer, the bone conduction device may include one or more of a receiver (e.g., for wireless communications), a battery, an active noise controller (e.g., a micro-controller and driver), or the like. External power could also be used to power the bone conduction device.

The inflatable harness may include an inflatable tube, including where such an inflatable tube is disposed at least generally in proximity to a user's ear when the respiratory mask system is being worn. The bone conduction device may be positioned on the inflatable harness to dispose a bone conduction transducer in front of a user's ear, below a user's ear, behind a user's year, or at any other appropriate position relative to a user's ear, all when the user is wearing the respiratory mask system. Inflation of the inflatable harness (including a tube on which the bone conduction device is mounted) may press the bone conduction transducer against the user's head to enhance the audio provided to the user.

A support may be mounted directly on the inflatable harness, and the bone conduction device may extend from the support to dispose the bone conduction transducer in spaced relation to the inflatable harness so as to be engageable with a user when the respiratory mask system is being worn. The noted support may be flexible (e.g., so as to expand during inflation of the inflatable harness), may be movable along a length dimension of the inflatable harness (e.g., for adjusting a position where the bone conduction transducer engages the user when the respiratory mask system is being worn), or both.

A mount may be positioned on the inflatable harness, for instance on an inflatable tube of the inflatable harness. The above-noted support may be attached to this mount so as to be retained in a fixed position relative to the mount (at least relative to/along the length dimension of the portion of the inflatable harness on which the mount is installed). The bone conduction device may extend from the support to dispose the bone conduction transducer in spaced relation to the inflatable harness so as to be engageable with a user when the respiratory mask system is being worn.

A cylinder may be mounted on the inflatable harness, for instance such that an inflatable tube of the inflatable harness extends through the cylinder. The bone conduction device (at least the bone conduction transducer for the bone conduction device) may be mounted on/incorporated by an outer perimeter of this cylinder. As such, the bone conduction transducer may directly interface with a user when the respiratory mask system is being worn.

Various aspects of the present disclosure are also addressed by the following examples and in the noted combinations:

1. An respiratory mask system, comprising:

a mask;

an inflatable harness interconnected with said mask;

an oxygen line fluidly interconnectable with said mask; and

a bone conduction device interconnected with said inflatable harness and comprising a bone conduction transducer.

2. The respiratory mask system of example 1, wherein said mask provides an enclosed space that includes a user's nose and mouth but excludes a user's eyes.

3. The respiratory mask system of example 1, wherein said mask comprises a full-face mask.

4. The respiratory mask system of any of examples 1-3, wherein said inflatable harness comprises an inflatable tube that is disposable in proximity to a user's ear, wherein said bone conduction device is interconnected with said inflatable tube.

5. The respiratory mask system of any of examples 1-4, wherein said bone conduction device extends from a support which in turn is mounted directly on said inflatable harness, wherein said bone conduction transducer is spaced from said inflatable harness.

6. The respiratory mask system of example 5, wherein said support is flexible.

7. The respiratory mask system of any of examples 5-6, wherein said support is slidably mounted on said inflatable harness for adjustable movement along a length dimension of a corresponding portion of said inflatable harness.

8. The respiratory mask system of any of examples 1-4, further comprising a mount positioned on said inflatable harness and a support attached to said mount, wherein said bone conduction device extends from said support to dispose said bone conduction transducer in spaced relation to said inflatable harness.

9. The respiratory mask system of example 8, wherein said support is anchored to said mount.

10. The respiratory mask system of any of examples 1-4, further comprising a cylinder mounted on said inflatable harness, wherein an outer perimeter of said cylinder comprises said bone conduction transducer.

11. The respiratory mask system of any of examples 1-10, wherein said bone conduction device further comprises an active noise controller.

12. A method of providing audio for an respiratory mask system, comprising:

donning a mask, wherein said mask encloses at least one of a nose and a mouth of a user;

positioning an inflatable harness on a head of said user;

disposing a bone conduction transducer in contact with said user, wherein a bone conduction device comprises said bone conduction transducer, and wherein said bone conduction device is interconnected with said inflatable harness;

providing audio to said user through bone conduction transducer; and

providing oxygen to said mask.

13. The method of example 12, wherein said user is at least one of a pilot or an aircraft crewmember.

14. The method of any of examples 12-13, further comprising inflating said inflatable harness, wherein said disposing is executed in response to said inflating.

15. The method of any of examples 12-13, further comprising inflating said inflatable harness, wherein said inflating comprises pressing said bone conduction transducer against said user.

16. The method of any of examples 12-15, further comprising:

adjusting of a position of said bone conduction transducer relative to and along a length dimension of a corresponding portion of said inflatable harness.

17. The method of any of examples 12-16, wherein said disposing comprises said bone conduction transducer being in contact with said user in proximity to and in front of an ear.

18. The method of any of examples 12-16, wherein said disposing comprises said bone conduction transducer being in contact with said user in proximity to and behind an ear.

19. The method of any of examples 12-16, wherein said disposing comprises said bone conduction transducer being in contact with a tragus of an ear of said user.

20. The method of any of examples 12-19, further comprising operating an active noise controller in proximity to said bone conduction transducer, wherein said bone conduction device further comprises said active noise controller.

21. The method of any of examples 12-19, further comprising using a micro-controller and a driver to detect an air conduction acoustic wave and generate an inverted acoustic bone conduction wave to cancel said air conduction acoustic wave, wherein said bone conduction device further comprises said micro-controller and said driver.

22. The method of any of examples 12-21, wherein a support is mounted on an inflatable tube of said inflatable harness, wherein said bone conduction device extends from said support to dispose said bone conduction transducer in spaced relation to said inflatable harness.

23. The method of any of examples 12-21, wherein a first support is mounted on an inflatable tube of said inflatable harness, wherein a second support is mounted to said first support, and wherein said bone conduction device extends from said second support to dispose said bone conduction transducer in spaced relation to said inflatable harness.

24. The method of any of examples 12-21, wherein a cylinder is mounted on an inflatable tube of said inflatable harness, wherein an outer perimeter of said cylinder comprises said bone conduction transducer.

### BRIEF DESCRIPTION OF THE DRAWINGS

The subject matter of the present disclosure is particularly pointed out and distinctly claimed in the concluding portion of the specification. An understanding of the present disclosure may be further facilitated by referring to the following detailed description and claims in connection with the following drawings. While the drawings illustrate various embodiments employing the principles described herein, the drawings do not limit the scope of the claims. Reference to “in accordance with various embodiments” in this Brief Description of the Drawings also applies to the corresponding discussion in the Detailed Description.

FIG. 1 is a perspective view of a respiratory mask system in accordance with various embodiments.

FIG. 2 is a perspective view of a respiratory mask system in accordance with various embodiments.

FIG. 3 is a side view of the respiratory mask system of FIG. 1 being worn by a user, but with an integrated a bone conduction transducer in accordance with various embodiments.

FIG. 4 is a side view of the respiratory mask system of FIG. 2 being worn by a user, but with an integrated bone conduction transducer in accordance with various embodiments.

FIG. 5 is a side view of the respiratory mask system of FIG. 2 being worn by a user, but with an integrated bone conduction transducer in accordance with various embodiments.

FIG. 6 is an enlarged view of the integration of the bone conduction transducer shown in FIG. 5.

FIG. 7 is a side view of the respiratory mask system of FIG. 2 being worn by a user, but with an integrated bone conduction transducer in accordance with various embodiments.

FIG. 8 is an enlarged view of the integration of the bone conduction transducer shown in FIG. 7.

FIG. 9 is a schematic of a bone conduction device that may be used by a respiratory mask system.

### DETAILED DESCRIPTION

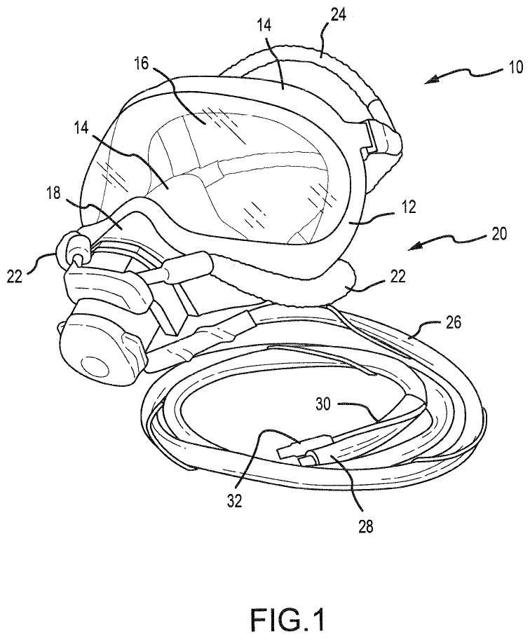

A respiratory mask system is illustrated in FIG. 1 and is identified by reference numeral 10. The respiratory mask system 10 may be used for any appropriate application, including for aircraft applications such as for crew members in the cockpit and including the pilot(s). The respiratory mask system 10 includes a mask 12 that is of a full-face configuration and thereby includes a lens 16. A seal 14 may extend about an entire perimeter of the mask 12 to enclose the user's nose, mouth, and eyes within the mask 12. At least part of the seal 14 may be positioned along at least a portion of a frame for the mask 12.

The mask 10 includes an inflatable harness 20 having a pair of tubes 22 that extend from a housing 18 and thereafter along the side of the face of a user (and may further extend along the back of the head of the user, in which case the inflatable harness 20 may be characterized as including a U-shaped tube with a pair of side sections) when the respiratory mask system 10 is being worn. One or more interconnecting tubes 24 of the inflatable harness 20 may extend between these tubes 22. The inflatable harness 20 may be inflated using any appropriate fluid source and including one or more gasses.

An oxygen supply tube 26 includes an oxygen connector 28 (connectable to an oxygen source) and extends to the housing 18 for the respiratory mask system 10. Although oxygen provided through the oxygen supply tube 26 could be used to inflate the inflatable harness 20, the inflatable harness 20 may be fluidly connected to a different fluid source that is separately activatable from the flow of oxygen through the oxygen supply tube 26. The respiratory mask system 10 further includes an audio line 30 and a corresponding audio connector 32. The audio line 30 could be interconnected with a communications system of an aircraft.

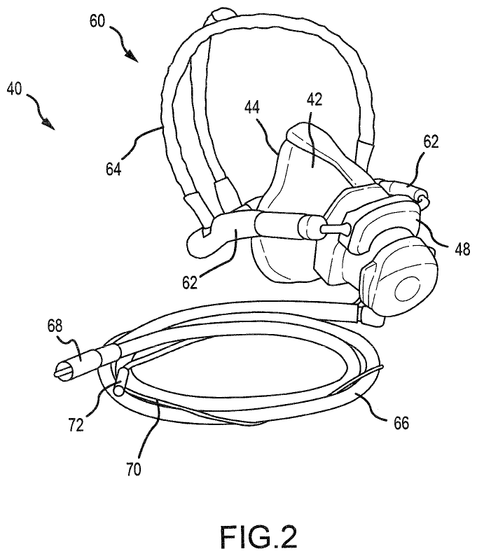

A respiratory mask system is illustrated in FIG. 2 and is identified by reference numeral 40. The respiratory mask system 40 may be used for any appropriate application, including for aircraft applications such as for crew members in the cockpit and including the pilot(s). A seal 44 may extend about an entire perimeter of the mask 42 to enclose both the user's nose and mouth within the mask 42 (but not the user's eyes). At least part of the seal 44 may be positioned along at least a portion of a frame for the mask 42.

The mask 42 includes an inflatable harness 60 having a pair of tubes 62 that extend from a housing 48 and thereafter along the side of the face of a user (and may further extend along the back of the head of the user, in which case the inflatable harness 60 may be characterized as including a U-shaped tube with a pair of side sections) when the respiratory mask system 40 is being worn. One or more interconnecting tubes 64 of the inflatable harness 60 may extend between these tubes 62. The inflatable harness 60 may be inflated using any appropriate fluid source and including one or more gasses.

An oxygen supply tube 66 includes an oxygen connector 68 (connectable to an oxygen source) and extends to the housing 48 for the respiratory mask system 40. Although oxygen provided through the oxygen supply tube 66 could be used to inflate the inflatable harness 60, the inflatable harness 60 may be fluidly connected to a different fluid source that is separately activatable from the flow of oxygen through the oxygen supply tube 66. The respiratory mask system 40 further includes an audio line 70 and a corresponding audio connector 72. The audio line 70 could be interconnected with a communications system of an aircraft.

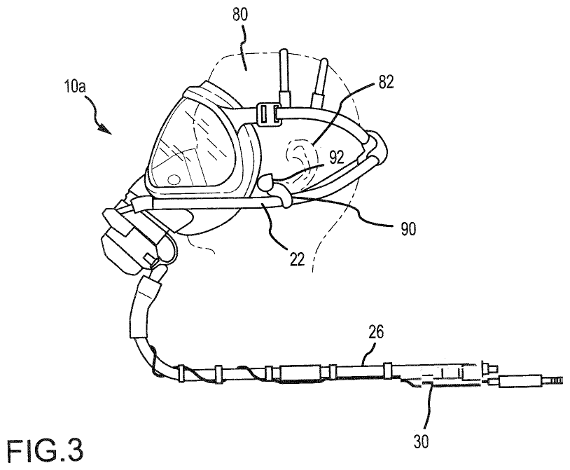

FIG. 3 illustrates a variation of the respiratory mask system 10 of FIG. 1, namely a respiratory mask system 10a (e.g., reusable) that includes an integrated bone conduction device (e.g., for providing audio to the user 80) and that is shown being worn by a user 80. The audio line 30 in the case of the respiratory mask system 10a may be operatively interconnected with one or more microphones and one or more speakers incorporated by the respiratory mask system 10a and as will be discussed in more detail below.

A first support 90 is mounted on an inflatable tube 22 in the case of the respiratory mask system 10a. The bone conduction device is secured to this first support 90 and extends therefrom to dispose a bone conduction transducer 92 in spaced relation to the inflatable tube 22 so as to be engageable with the user 80 (e.g., the bone conduction transducer 92 could itself extend from the first support 90). Inflation of the inflatable harness 20 (including the tube 22) may press the bone conduction transducer 92 against the user 80 (preferably against a boney structure) to provide an enhanced delivery of audio to the user 80. The respiratory mask system 10a would typically be configured to integrate a first support 90 and a corresponding bone conduction transducer 92 with each tube 22 of the inflatable harness 20 (e.g., one bone conduction transducer 92 for each ear 82 of the user 80).

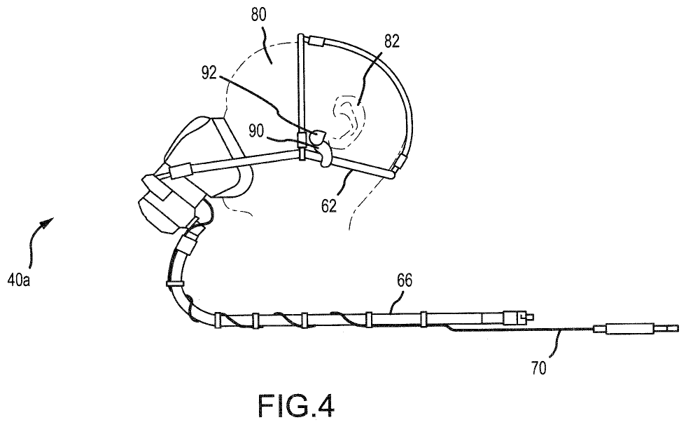

The first support 90 may be of a configuration such that it flexes or expands in response to inflation of the tube 22 (e.g., the first support 90 may encircle the corresponding tube 22). Moreover, the first support 90 may be slidably interconnected with the tube 22 to allow for adjustment of the position of the first support 90 along a length dimension of the tube 22 (and thereby a corresponding adjustment of the location where the bone conduction transducer 92 engages the user 80). FIG. 3 illustrates the first support 90 being positioned along the tube 22 to position the bone conduction transducer 92 against the user 80 at a location that is forward of a corresponding ear 82. However, the first support 90 could also be positioned along the tube 22 to position the bone conduction transducer 92 against the user 80 at different locations, such as shown in FIG. 4 that will now be addressed.

FIG. 4 illustrates a variation of the respiratory mask system 40 of FIG. 2, namely a respiratory mask system 40a (e.g., reusable) that includes an integrated bone conduction device (e.g., for providing audio to the user 80) and that is shown being worn by a user 80. The audio line 70 in the case of the respiratory mask system 40a may be operatively interconnected with one or more microphones and one or more speakers incorporated by the respiratory mask system 40a and as will be discussed in more detail below.

The above-noted first support 90 is mounted on an inflatable tube 62 in the case of the respiratory mask system 40a. The bone conduction device is secured to this first support 90 and extends therefrom to dispose a bone conduction transducer 92 in spaced relation to the inflatable tube 62 so as to be engageable with the user 80 (e.g., the bone conduction transducer 92 could itself extend from the first support 90). Inflation of the inflatable harness 60 (including the tube 62) may press the bone conduction transducer 92 against the user 80 (preferably against a boney structure) to provide an enhanced delivery of audio to the user 80. The respiratory mask system 40a would typically be configured to integrate a first support 90 and a corresponding bone conduction transducer 92 with each tube 62 of the inflatable harness 60 (e.g., one bone conduction transducer 92 for each ear 82 of the user 80).

The first support 90 may be of a configuration such that it flexes or expands in response to inflation of the tube 62 (e.g., the first support 90 may encircle the corresponding tube 62). Moreover, the first support 90 may be slidably interconnected with the tube 62 to allow for adjustment of the position of the first support 90 along a length dimension of the tube 62 (and thereby a corresponding adjustment of the location where the bone conduction transducer 92 engages the user 80). FIG. 4 illustrates the first support 90 being positioned along the tube 62 to position the bone conduction transducer 92 against the user 80 at a location that is in behind a corresponding ear 82. However, the first support 90 could also be positioned along the tube 62 to position the bone conduction transducer 92 against the user 80 at a location shown in FIG. 3 addressed above.

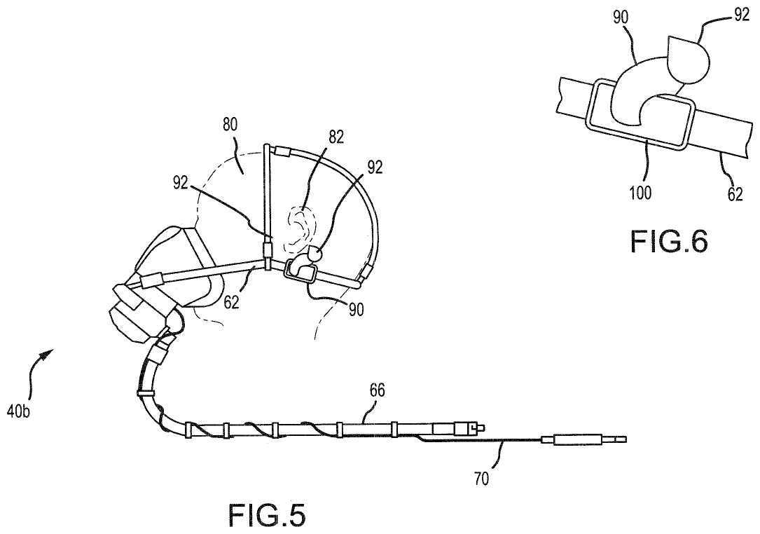

FIG. 5 illustrates a variation of the respiratory mask system 40 of FIG. 2, namely a respiratory mask system 40b (e.g., reusable) that includes an integrated bone conduction device (e.g., for providing audio to the user 80) and that is shown being worn by a user 80. The audio line 70 in the case of the respiratory mask system 40b may be operatively interconnected with one or more microphones and one or more speakers incorporated by the respiratory mask system 40b and as will be discussed in more detail below.

The bone conduction device in the case of the respiratory mask system 40b is secured to the above-noted first support 90 and extends therefrom to dispose a bone conduction transducer 92 in spaced relation to the inflatable tube 62 so as to be engageable with the user 80 (e.g., the bone conduction transducer 92 could itself extend from the first support 90). Instead of the first support 90 being mounted directly on the inflatable tube 62 as in the respiratory mask system 40a of FIG. 4, the first support 90 for the respiratory mask system 40b of FIG. 5 is instead appropriately secured to a mount or second support 100, which in turn is mounted on the inflatable tube 62 (see also the enlarged view of FIG. 6). Inflation of the inflatable harness 60 (including the tube 62) may press the bone conduction transducer 92 against the user 80 (preferably against a boney structure) to provide an enhanced delivery of audio to the user 80. The respiratory mask system 40b would typically be configured to integrate a first support 90 and a corresponding bone conduction transducer 92 with each tube 62 of the inflatable harness 60 (e.g., one bone conduction transducer 92 for each ear 82 of the user 80).

The mount 100 may be of a configuration such that it flexes or expands in response to inflation of the tube 62, or the mount 100 may be of a configuration such that it does not substantially flex or expand in relation to inflation of the tube 62. The mount 100 may encircle the corresponding tube 62. The mount 100 could be slidably interconnected with the tube 62 to allow for adjustment of the position of the first support 90 along a length dimension of the tube 62 (and thereby a corresponding adjustment of the location where the bone conduction transducer 92 engages the user 80), or the mount 100 could be retained in a fixed position along the length dimension of the tube 62. In the case of the respiratory mask system 40b of FIG. 5, the first support 90 may be disposed along the tube 62 to position the bone conduction transducer 92 against the user 80 at a location that is in behind a corresponding ear 82 as shown, or could be disposed along the tube 62 to position the bone conduction transducer 92 against the user 80 at a location that is forward of the corresponding ear 82 (e.g., FIG. 3).

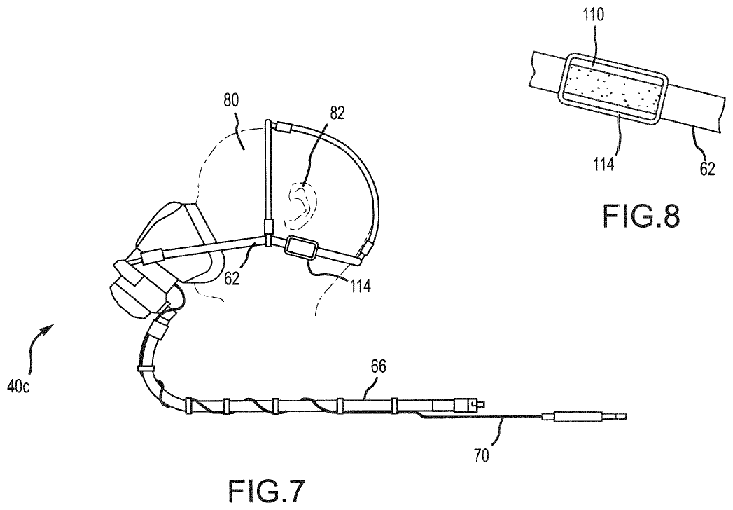

FIG. 7 illustrates a variation of the respiratory mask system 40 of FIG. 2, namely a respiratory mask system 40c (e.g., reusable) that includes an integrated bone conduction device (e.g., for providing audio to the user 80) and that is shown being worn by a user 80. The audio line 70 in the case of the respiratory mask system 40c may be operatively interconnected with one or more microphones and one or more speakers incorporated by the respiratory mask system 40c and as will be discussed in more detail below.

The integrated bone conduction device in the case of the respiratory mask system 40c may include a cylinder 110, with an annular bone conduction transducer 114 of the integrated bone conduction device being disposed about an outer perimeter of this cylinder 110 (see also the enlarged view of FIG. 8). The entirety of the bone conduction device could also be disposed about the outer perimeter of the cylinder 100. In any case, the inflatable tube 62 extends through the cylinder 110. Inflation of the inflatable harness 60 (including the tube 62) may press the bone conduction transducer 114 against the user 80 (preferably against a boney structure) to provide an enhanced delivery of audio to the user 80. The respiratory mask system 40c would typically be configured to integrate a cylinder 110 and a corresponding bone conduction transducer 114 with each tube 62 of the inflatable harness 60 (e.g., one bone conduction transducer 114 for each ear 82 of the user 80).

The cylinder 110 may be of a configuration such that it flexes or expands in response to inflation of the tube 62, or the cylinder 110 may be of a configuration such that it does not substantially flex or expand in relation to inflation of the tube 62. The cylinder 110 could be slidably interconnected with the tube 62 to allow for adjustment of the position of the cylinder 110 along a length dimension of the tube 62 (and thereby a corresponding adjustment of the location where the bone conduction transducer 114 engages the user 80), or the cylinder 110 could be retained in a fixed position along the length dimension of the tube 62. In the case of the respiratory mask system 40c of FIG. 7, the cylinder 110 may be disposed along the tube 62 to position the bone conduction transducer 114 against the user 80 at a location that is directly below the corresponding ear 82 as shown in FIG. 7, may be disposed along the tube 62 to position the bone conduction transducer 114 against the user 80 at a location that is behind a corresponding ear 82 (e.g., FIG. 4), or could be disposed along the tube 62 to position the bone conduction transducer 114 against the user 80 at a location that is forward of the corresponding ear 82 (e.g., FIG. 3).

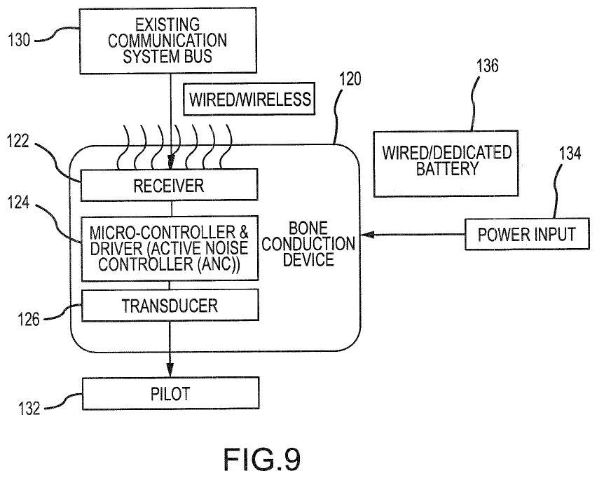

A schematic of a bone conduction device is presented in FIG. 9, is identified by reference numeral 120, and may be used in relation to the respiratory mask system 10a of FIG. 3, in relation to the respiratory mask system 40a of FIG. 4, in relation to the respiratory mask system 40b of FIG. 5, or in relation to the respiratory mask system 40c of FIG. 7. The bone conduction device 120 includes a bone conduction transducer 126 that provides audio to a user or pilot 132.

In at least certain instances, a respiratory mask system incorporating the bone conduction device 120 may be used in a noisy environment (e.g., during a catastrophic event for an aircraft, such as in the case of window pane breakage in the cockpit or elsewhere in the aircraft and that may generate wind noise due to a sudden depressurization of the cockpit/aircraft; due to loud external noise within an aircraft, such due to malfunctioning equipment). As such, the bone conduction device 120 may include one or more noise-canceling features. For instance, the bone conduction device 120 may include an active noise controller 124 (e.g., a micro-controller and driver), which can be configured to detect air conduction acoustic waves and generate an inverted acoustic bone conduction wave to cancel such air conduction acoustic waves. The bone conduction device 120 could also be incorporated by a respiratory mask system so as to dispose the bone conduction transducer 126 on the tragus of a user's ear.

The bone conduction device 120 may be configured to communicate in any appropriate manner with an external device/system, such as a cockpit communication system bus 130 of an aircraft, including via a wired configuration or a wireless configuration (where the bone conduction device 120 could then include an appropriate receiver 122). Any appropriate power source may be used for the bone conduction device 120, including a battery 136 incorporated by the bone conduction device 120 or by a wired connection with an external power unit 134 (e.g., of an aircraft).

Any feature of any other various aspects addressed in this disclosure that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the singular. Moreover, any failure to use phrases such as “at least one” also does not limit the corresponding feature to the singular. Use of the phrase “at least substantially,” “at least generally,” or the like in relation to a particular feature encompasses the corresponding characteristic and insubstantial variations thereof (e.g., indicating that a surface is at least substantially or at least generally flat encompasses the surface actually being flat and insubstantial variations thereof). Finally, a reference of a feature in conjunction with the phrase “in one embodiment” does not limit the use of the feature to a single embodiment.

The foregoing description has been presented for purposes of illustration and description. Furthermore, the description is not intended to limit the invention to the form disclosed herein. Consequently, variations and modifications commensurate with the above teachings, and skill and knowledge of the relevant art, are within the scope of the present disclosure. Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An respiratory mask system, comprising:
a mask;
an inflatable harness interconnected with said mask;
an oxygen line fluidly interconnectable with said mask; and
a bone conduction device interconnected with said inflatable harness and comprising a bone conduction transducer.

2. The respiratory mask system of claim 1, wherein said mask provides an enclosed space that includes a user's nose and mouth but excludes a user's eyes.

3. The respiratory mask system of claim 1, wherein said mask comprises a full-face mask.

4. The respiratory mask system of claim 1, wherein said inflatable harness comprises an inflatable tube that is disposable in proximity to a user's ear, wherein said bone conduction device is interconnected with said inflatable tube.

5. The respiratory mask system of claim 1, wherein said bone conduction device extends from a support which in turn is mounted directly on said inflatable harness, wherein said bone conduction transducer is spaced from said inflatable harness.

6. The respiratory mask system of claim 5, wherein said support is flexible.

7. The respiratory mask system of claim 5, wherein said support is slidably mounted on said inflatable harness for adjustable movement along a length dimension of a corresponding portion of said inflatable harness.

8. The respiratory mask system of claim 1, further comprising a mount positioned on said inflatable harness and a support attached to said mount, wherein said bone conduction device extends from said support to dispose said bone conduction transducer in spaced relation to said inflatable harness.

9. The respiratory mask system of claim 8, wherein said support is anchored to said mount.

10. The respiratory mask system of claim 1, further comprising a cylinder mounted on said inflatable harness, wherein an outer perimeter of said cylinder comprises said bone conduction transducer.

11. The respiratory mask system of claim 1, wherein said bone conduction device further comprises an active noise controller.

12. A method of providing audio for an respiratory mask system, comprising:
donning a mask, wherein said mask encloses at least one of a nose and a mouth of a user;
positioning an inflatable harness on a head of said user;
disposing a bone conduction transducer in contact with said user, wherein a bone conduction device comprises said bone conduction transducer, and wherein said bone conduction device is interconnected with said inflatable harness;
providing audio to said user through bone conduction transducer; and
providing oxygen to said mask.

13. The method of claim 12, wherein said user is at least one of a pilot or an aircraft crewmember.

14. The method of claim 12, further comprising inflating said inflatable harness, wherein said disposing is executed in response to said inflating.

15. The method of claim 12, further comprising inflating said inflatable harness, wherein said inflating comprises pressing said bone conduction transducer against said user.

16. The method of claim 12, further comprising:
adjusting of a position of said bone conduction transducer relative to and along a length dimension of a corresponding portion of said inflatable harness.

17. The method of claim 12, wherein said disposing comprises said bone conduction transducer being in contact with said user in proximity to and in front of or behind an ear.

18. The method of claim 12, wherein said disposing comprises said bone conduction transducer being in contact with a tragus of an ear of said user.

19. The method of claim 12, further comprising operating an active noise controller in proximity to said bone conduction transducer, wherein said bone conduction device further comprises said active noise controller.

20. The method of claim 12, further comprising using a micro-controller and a driver to detect an air conduction acoustic wave and generate an inverted acoustic bone conduction wave to cancel said air conduction acoustic wave, wherein said bone conduction device further comprises said micro-controller and said driver.
